(19) United States
(12) Patent Application Publication
(10) Pub. No.: US 2004/0047429 A1
(43) Pub. Date: Mar. 11, 2004

(54) RF digital transmitter

(76) Inventor: Weichan Hsu, Los Altos, CA (US)

Correspondence Address: RABIN & BERDO, P.C., SUITE 500, 1101 14th STREET, N.W., WASHINGTON, DC, 20005, US

(21) Appl. No.: 10/235,943

(22) Filed: Sep. 6, 2002

(51) Int. Cl. H04L 27/04; H04L 27/12

(52) U.S. Cl. 375/295

(57) ABSTRACT

An RF digital transmitter. The transmitter comprises a modulator receiving and modulating a digital base-band signal, a local oscillator generating a digital carrier signal, a mixer receiving the digital base-band and carrier signal, and implementing multiplication of the digital base-band and carrier signal to generate a transmission signal, and a switching power amplifier amplifying the transmission signal.

### BACKGROUND OF THE INVENTION

1. Field of the Invention

The present invention relates to an RF transmitter, particularly to an RF digital transmitter with low power consumption.

2. Description of the Prior Art

FIG. 1 illustrates the functional diagram and the basic elements of a digital communication system of a prior art. The digital communication system comprises an information source and input transducer 11, source encoder 12, channel encoder 13, and digital modulator 14 at the transmitting end, and a digital demodulator 15, channel decoder 16, source decoder 17 and output transducer 18 at the receiving end. The signal is sent from the transmitting end to the receiving end through a channel 19. The communication channel is the physical medium that is used to send the signal from the transmitter to the receiver. In wireless transmission, the channel 19 may be the atmosphere (free space). The information source and input transducer 11 may output an analog signal, such as an audio or video signal, or a digital signal, such as the output of a teletype machine, that is discrete in time and has a finite number of output characters. The source encoder 12 implements the process of efficiently converting the signals output from the information source and input transducer 11 into a sequence of binary digits, called an information sequence. The purpose of the channel encoder 13 is to introduce, in a controlled manner, some redundancy in the binary information sequence that can be used at the receiver to overcome the effects of noise and interference encountered in the transmission of the signal through the channel 19. The digital modulator 14 serves as the interface to the communication channel 19. The primary purpose of the digital modulator 14 is to map the binary information sequence into signal waveforms.

At the receiving end of the digital communication system are a digital demodulator 15, channel decoder 16 and source decoder 17 to reconstruct the original signal from the source.

In the channel 19, low frequency signals cannot be transmitted through the atmosphere over a long distance. It is possible only when the low frequency signals are carried on RF carrier signals. Therefore, there must be an RF transmitter in the transmitting end of the digital communication system.

FIG. 2 is a diagram showing a conventional RF transmitter used in the transmitting end of the digital communication system. The RF transmitter comprises a D/A converter 21, a local oscillator 13, a mixer 25 and a power amplifier 27. The D/A converter 21 receives the digital base-band signal DBS with a baseband frequency f_{BB}, for example less than 10 MHz, and converts it into an analog base-band signal ABS. The local oscillator 23 generates an analog carrier signal ACS with a high Local oscillator frequency f_{LO}, for example 2.4 GHz or 5 GHz. The mixer 25 receives the analog base-band signal ABS and the analog carrier signal ACS, and implements signal multiplication of them. This causes a frequency shift of the signal ABS in frequency domain and produces a semi-transmission signal STS. The semi-transmission signal STS is further amplified by the power amplifier 27 and then a transmission signal TS is transmitted by an antenna. The power amplifier 27 may be a class A, B or C linear power amplifier shown in FIG. 9.

FIGS. 3a, 3b and 3c are diagrams showing the relation between the signals ABS, ACS and TS in frequency domain respectively. The signal ABS has a bandwidth BW (lower than 10 MHz) and a central frequency 0. The signal ACS has a frequency RF (for example, it may be 2.4 GHz or 5 GHz). After being mixed with analog base-band signal ABS by the mixer 25, the signals ABS and ACS are mixed into the signal TS with the central frequency RF and bandwidth BW. Thus, the analog base-band signal ABS is carried on the analog carrier signal ACS and can be transmitted through the channel over a long distance.

However, there are some drawbacks in the conventional RF transmitter.

1. The operation of the D/A converter and mixer easily generates a lot of noise. Signal distortion also easily results from the nonlinear transformation of the converter 21 and mixer 25.

2. It requires much more effort for the circuit designers to design the layouts for the conventional RF transmitter composed of analog circuits.

3. The conventional RF transmitter suffers high power consumption due to class A, B, AB or C power amplifier wherein a DC bias always exists in the output signal.

### SUMMARY OF THE INVENTION

Therefore, the object of the present invention is to provide a digital RF transmitter with low power consumption. The digital RF transmitter is easier for the circuit designers to design the layout for the corresponding digital circuit. A mixer in the digital RF transmitter simply implements multiplication of digital bits from signals and does not cause nonlinear transformation. A power amplifier in the digital RF transmitter may be a class D, E or F power amplifier, which eliminates the unnecessary power consumption resulting from the DC bias in the output signal.

The present invention provides an digital RF digital transmitter. The transmitter comprises a digital modulator for receiving and modulating a digital base-band signal, a local oscillator for generating a digital carrier signal, a mixer for receiving the digital base-band and carrier signal and implementing multiplication of the digital base-band and carrier signal to generate a transmission signal, and a switching power amplifier for amplifying the transmission signal.

The present invention further provides a method for RF digital transmission. The method comprises the step of receiving and modulating a digital base-band signal, the step of generating a digital carrier signal, the step of receiving the digital base-band and carrier signal, and the step of implementing multiplication of the digital base-band and carrier signal to generate a transmission signal, and the step of amplifying the transmission signal.

The present invention also provides an digital RF digital transmitter. The transmitter comprises a digital modulator for receiving and modulating a N-bit digital base-band signal with a frequency fₛ, and generating a 1-bit modulated digital base-band signal with a frequency N×fₛ, a local oscillator for generating a digital carrier signal, a digital mixer for receiving the 1-bit modulated digital base-band signal and digital carrier signal, and implementing multiplication thereof to generate a transmission signal, and a switching power amplifier for amplifying the transmission signal.

The present invention provides a method for RF digital transmission. The method comprises the step of receiving and modulating a N-bit digital base-band signal with a frequency fₛ, and generating a 1-bit modulated digital base-band signal with a frequency N×fₛ, the step of generating a digital carrier signal, the step of receiving the 1-bit modulated digital base-band signal and digital carrier signal, and implementing multiplication thereof to generate a transmission signal, and the step of amplifying the transmission signal.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 illustrates the functional diagram and the basic elements of a digital communication system.

FIG. 2 is a block diagram showing a conventional RF transmitter used in the transmitting end of the digital communication system.

FIGS. 3a, 3b and 3c are diagrams showing the relation between the signals ABS, ACS and TS in frequency domain respectively.

FIG. 4 is a block diagram showing an RF transmitter used in the transmitting end of the digital communication system according to one embodiment of the present invention.

FIG. 5a˜5d are diagrams showing the relation between the signals MDBS, DCS, STS and TS in frequency domain respectively.

FIG. 6 is a flowchart of a method for RF transmission according to one embodiment of the present invention.

FIG. 7 is a diagram showing one embodiment of the modulator of the digital RF transmitter in FIG. 4.

FIGS. 8A and 8B shows one embodiment of the mixer circuit of the digital RF transmitter in FIG. 4 and its truth table.

FIG. 9 is a liner power amplifier, for example, a class A, B or C power amplifier.

FIG. 10 is a switching power amplifier, foe example, a class D, E or F power amplifier.

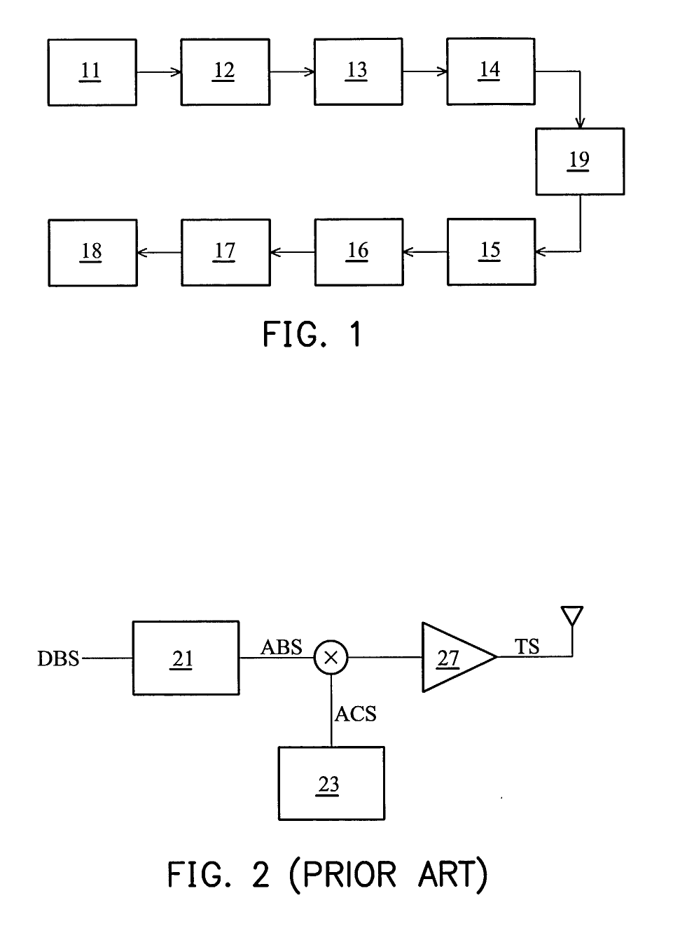

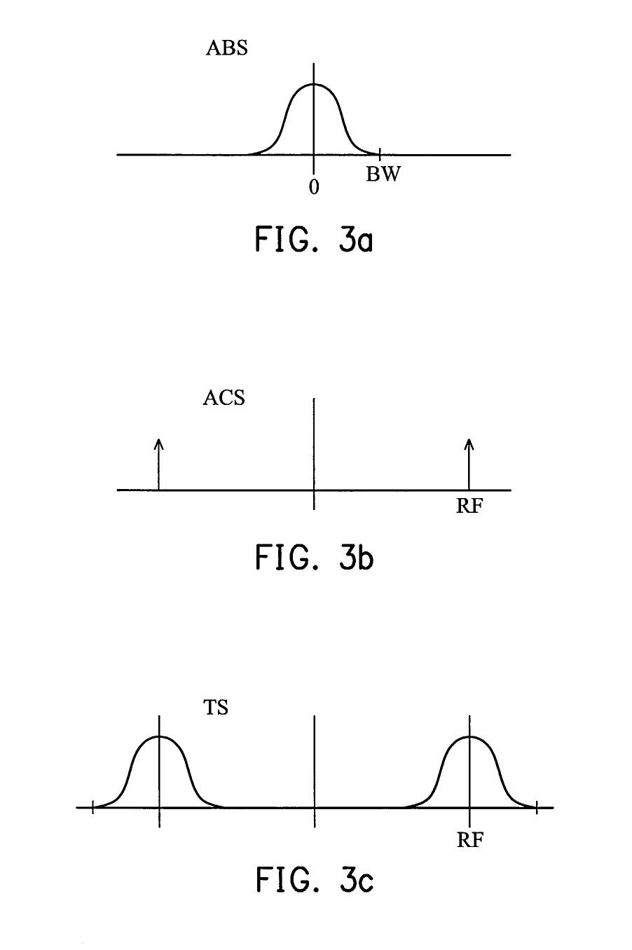

### DETAILED DESCRIPTION OF THE INVENTION

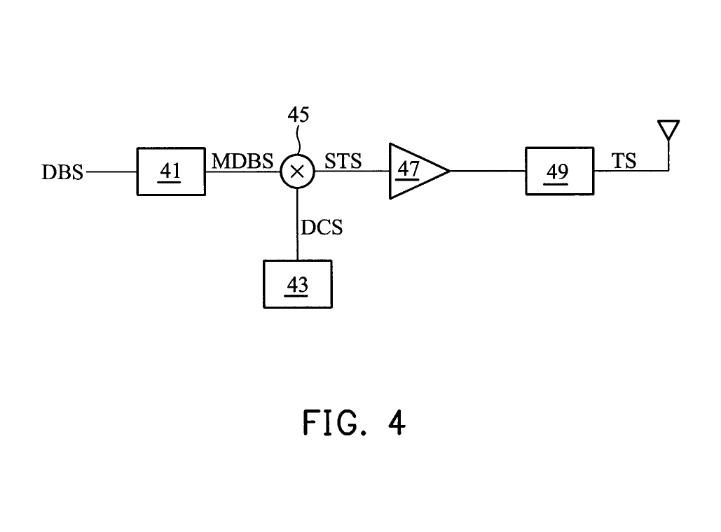

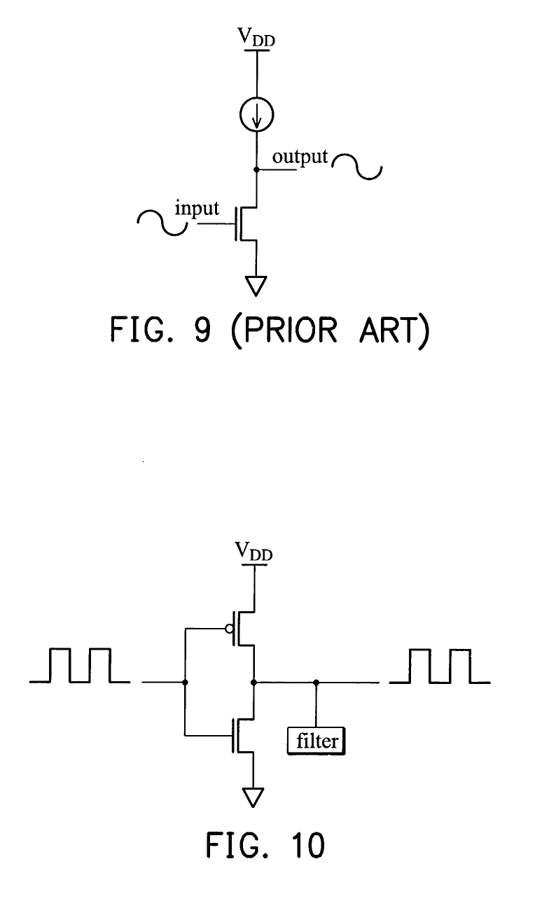

FIG. 4 is a block diagram showing an RF transmitter used in the transmitting end of the digital communication system according to one embodiment of the present invention. The RF transmitter comprises a digital modulator 41, a local oscillator 43, a digital mixer 45, a switching power amplifier 47 and a band-pass filter 49. The modulator 41 receives the digital base-band signal DBS with a bandwidth baseband frequency f_{BB}, for example lower than 10 MHz, and modulates it into a modulated digital base-band signal MDBS. The modulator 41 may comprise a noise shaping quantization circuit or over-sampling circuit disclosed in U.S. Pat. No. 5,068,661, which provides a substantial improvement in S/N ratio, implements bit compression resulting in a digital signal having a high resolution being converted to a digital signal having much lower resolution and reduces quantization noise level. The local oscillator 43 generates a digital carrier signal DCS with a Local oscillator frequency f_{LO}, for example 2.4 GHz or 5 GHz. The mixer 45 receives the modulated digital base-band signal MDBS and the digital carrier signal DCS, and then implements multiplication of the digital bits thereof. This causes a frequency shift of the signal MDBS in frequency domain and produces a semi-transmission signal STS. The semi-transmission signal STS is further amplified by the switching power amplifier 47 and filtered by the band-pass filter 49. Then, a transmission signal TS is transmitted by an antenna. The power amplifier 47 may be a class D, E or F power amplifier as shown in FIG. 10. The linear power amplifiers, for example, class A, class B and class C power amplifier etc. as shown in FIG. 9, are not suitable for amplifying the digital signal due to the lower efficiency. Power consumption is an important issue in the mobile RF transmitter application.

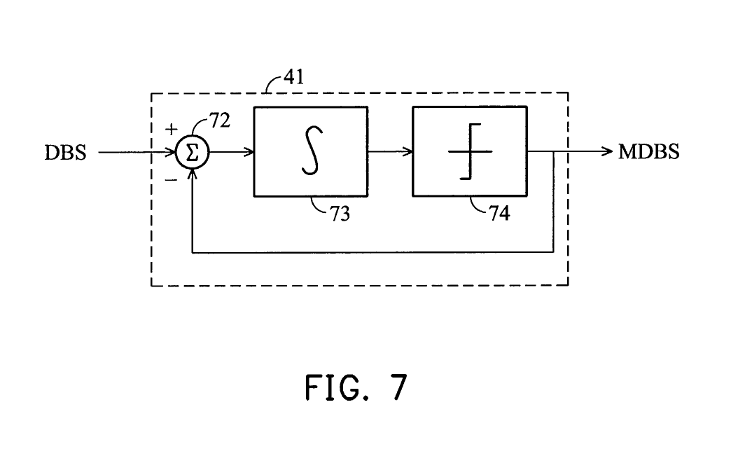

FIG. 7 is a block diagram showing one embodiment of the modulator 41 of the present invention. In this embodiment, the modulator 41 is a Sigma-Delta modulator, the Sigma-Delta modulator includes an adder 72, an accumulator 73 and a quantizer 74. The N-bit signal DBS into a one-bit signal with a frequency N×fₛ is input to the adder 72, wherein fₛ is the baseband sampling frequency of the signal DBS. Thus the frequency of output signal MDBS is also N×fₛ. The circuit of the quantizer 74 can be an AND gate circuit wherein a high logic level is output when the voltage output from the accumulator 73 to the gate is lower than 0V and a low logic level is output when the voltage output from the accumulator 73 to the gate is higher than 0V.

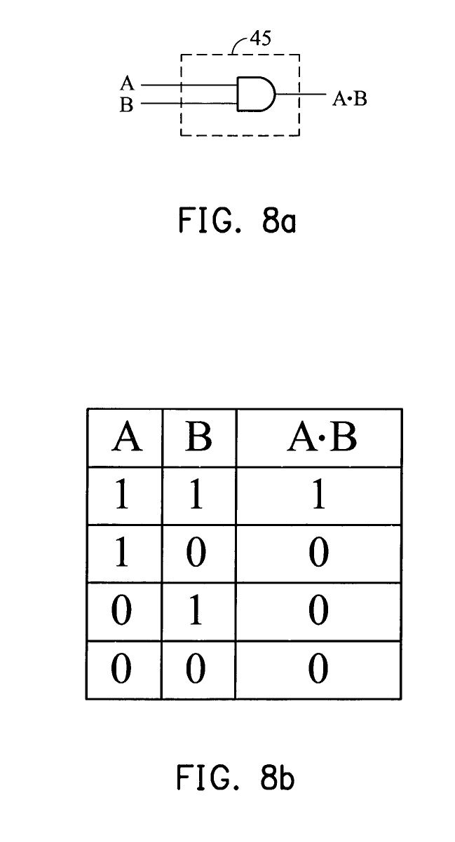

FIG. 8A is a block diagram showing one embodiment of the mixer 45 of the present invention. The mixer 45 may be an AND gate receiving bits A and B respectively from the signals MBDS and DCS. The output of the AND gate is a multiplication of A and B, as shown in the truth table of FIG. 8B.

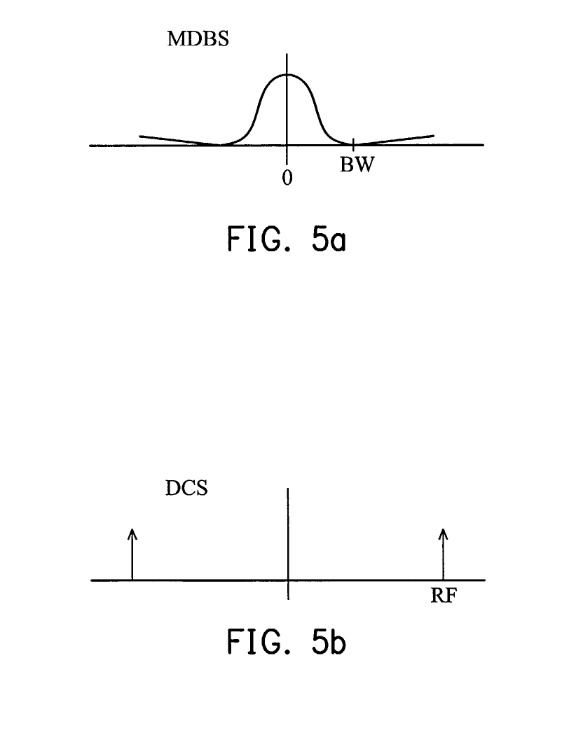

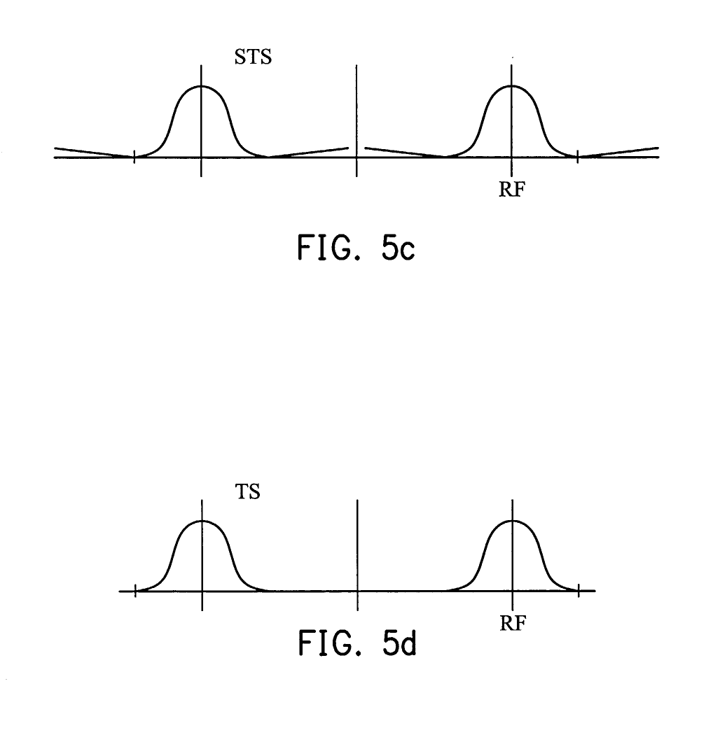

FIG. 5a˜5d are diagrams showing the relation between the signals MDBS, DCS, STS and TS in frequency domain respectively. The signal MDBS has a bandwidth BW (lower than 10 MHz) and a central frequency 0. Additionally, the signal MDBS also has signal components at higher frequencies. The signal DCS has a frequency RF (2.4 GHz or 5 GHz). After being mixed by the mixer 25, the signals MDBS and DCS are integrated into the signal STS with the central frequency RF and bandwidth BW. The band-pass filter 49 filters the signal MDBS and eliminates the signal components at the higher frequencies. Thus, the digital base-band signal DBS is carried on the digital carrier signal DCS and can be transmitted over a long distance.

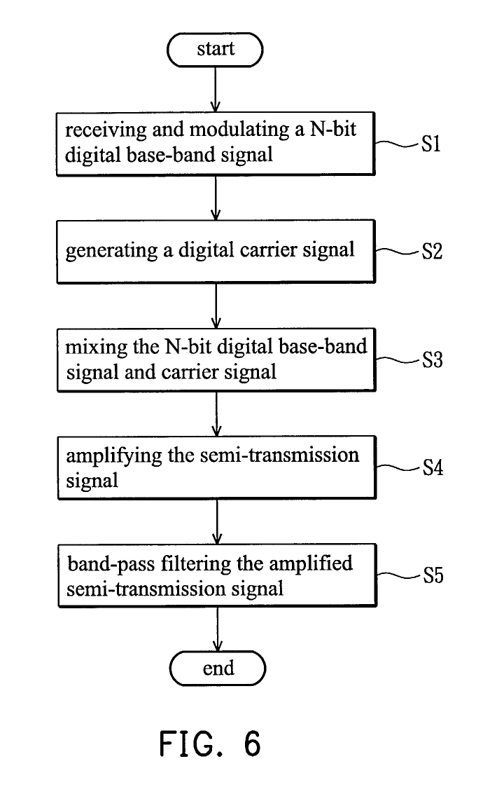

FIG. 6 is a flowchart of a method for RF transmission according to one embodiment of the invention.

In step S1, a N-bit digital base-band signal with a frequency fₛ is received and modulated, and accordingly a 1-bit modulated digital base-band signal with a frequency N×fₛ is generated. The modulation of the N-bit digital base-band signal may be Sigma-Delta modulation.

In step S2, a digital carrier signal is generated.

In step S3, the 1-bit modulated digital base-band signal and digital carrier signal are received, and multiplication of the two received signals is implemented to generate a semi-transmission signal.

In step S4, the semi-transmission signal is amplified by a class D, E or F power amplifier.

Finally, in step S5, the amplified semi-transmission signal is received and band-pass filtered, and then transmitted through an antenna.

In conclusion, the present invention provides a digital RF transmitter with low power consumption. The digital RF transmitter is easier for circuit designers to work on. A mixer in the digital RF transmitter simply implements multiplication of digital bits from signals and does not cause nonlinear transformation. A power amplifier in the digital RF transmitter may be a class D, E or F power amplifier, which eliminates the unnecessary power consumption resulting from the DC bias in the output signal.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An RF digital transmitter comprising:
a modulator for receiving a N-bit digital baseband frequency signal with a first frequency fs and modulating the digital base-band signal into a 1-bit modulated baseband frequency signal with a second frequency which is M times fs;
a local oscillator for generating a digital carrier signal;
a digital mixer for receiving the digital base-band and carrier signal, and implementing multiplication of the digital base-band and carrier signal to generate a transmission signal; and
a switching power amplifier for amplifying the transmission signal.

2. The RF digital transmitter as claimed in claim 1 further comprising a band-pass filter for receiving and band-pass filtering the amplified transmission signal.

3. The RF digital transmitter as claimed in claim 1, wherein the modulator comprises a noise shaping modulation means.

4. The RF digital transmitter as claimed in claim 1, wherein the modulator comprises a over-sampling quantization means.

5. The RF digital transmitter as claimed in claim 1, wherein the switching power amplifier is a class D amplifier.

6. The RF digital transmitter as claimed in claim 1, wherein the switching power amplifier is a class E amplifier.

7. The RF digital transmitter as claimed in claim 1, wherein the switching power amplifier is a class F amplifier.

8. The RF digital transmitter as claimed in claim 1, wherein the first frequency is a sampling frequency.

9. A method for RF digital transmission comprising the steps of:
receiving and modulating a digital base-band signal;
generating a digital carrier signal;
receiving the digital base-band and carrier signal, and implementing multiplication of the digital base-band and carrier signal to generate a transmission signal; and
amplifying the transmission signal.

10. The method as claimed in claim 9 further comprising the step of:
receiving and band-pass filtering the amplified transmission signal.

11. The method as claimed in claim 9, wherein the modulation of the digital base-band signal is Sigma-Delta modulation.

12. An RF digital transmitter comprising:
a digital modulator receiving and modulating a N-bit digital base-band signal with a frequency fₛ, and generating a 1-bit modulated digital base-band signal with a frequency N×fₛ;
a local oscillator generating a digital carrier signal;
a digital mixer receiving the 1-bit modulated digital base-band signal and digital carrier signal, and implementing multiplication thereof to generate a transmission signal; and
a switching power amplifier amplifying the transmission signal.

13. The RF digital transmitter as claimed in claim 12 further comprising a band-pass filter for receiving and band-pass filtering the amplified transmission signal.

14. A method for RF digital transmission comprising the steps of:
receiving and modulating a N-bit digital base-band signal with a frequency fₛ, and generating a 1-bit modulated digital base-band signal with a frequency N×fₛ;
generating a digital carrier signal;
receiving the 1-bit modulated digital base-band signal and digital carrier signal, and implementing multiplication thereof to generate a transmission signal; and
amplifying the transmission signal.

15. A method for RF digital transmission comprising:
noise shaping modulation means for receiving a N-bit digital baseband frequency signal with a first frequency fs and modulating the digital base-band signal into a 1-bit modulated baseband frequency signal with a second frequency which is M times fs;
local oscillation means for generating a digital carrier signal;
digital mixing means for receiving the digital base-band and carrier signal, and implementing multiplication of the digital base-band and carrier signal to generate a transmission signal; and
switching power amplifying means for amplifying the digital transmission signal.

16. The method as claimed in claim 15, wherein the first frequency is a sampling frequency.

17. The method as claimed in claim 15, wherein the noise shaping modulation means comprises over-sampling means.

18. The method as claimed in claim 15, wherein the noise shaping modulation means comprises noise shaping quantization means.

19. An RF digital transmitter comprising:
a noise shaping modulator for receiving a N-bit digital baseband frequency signal with a first frequency(sampling frequency) fs and modulating the digital base-band signal into a 1-bit modulated baseband frequency signal with a second frequency which is M times fs;
a local oscillator for generating a digital carrier signal;
digital mixing means for receiving the digital base-band and carrier signal, and implementing multiplication of the digital base-band and carrier signal to generate a transmission signal; and
switching power amplifier means for amplifying the digital transmission signal;
a band-pass filter for receiving and band-pass filtering the amplified transmission signal.

20. The RF digital transmitter as claimed in claim 19, wherein the modulation of the digital base-band signal comprises a Sigma-Delta modulation.

21. The RF digital transmitter as claimed in claim 19, wherein the switching power amplifier is a class D amplifier.

22. The RF digital transmitter as claimed in claim 19, wherein the switching power amplifier is a class E amplifier.

23. The RF digital transmitter as claimed in claim 19, wherein the switching power amplifier is a class F amplifier.

24. The RF digital transmitter as claimed in claim 19, wherein the noise shaping modulator comprises over-sampling means.

25. The RF digital transmitter as claimed in claim 19, wherein the noise shaping modulator comprises noise shaping quantization means.
